(19) United States
(12) Patent Application Publication
(10) Pub. No.: US 2025/0202539 A1
(43) Pub. Date: Jun. 19, 2025

(54) RECONFIGURABLE INTELLIGENT SURFACES (RIS) AIDED INITIAL ACCESS

(71) Applicant: InterDigital Patent Holdings, Inc., Wilmington, DE (US)

(72) Inventors: Ibrahim Hemadeh, Hemel Hempstead (GB); Allan Yingming Tsai, Boonton, NJ (US); Patrick Svedman, Stockholm (SE); Deepa Gurmukhdas Jagyasi, London (GB); Kyle Jung-Lin Pan, Saint James, NY (US); Tezcan Cogalan, London (GB); Guodong Zhang, Woodbury, NY (US); Arman Shojaeifard, London (GB)

(73) Assignee: InterDigital Patent Holdings, Inc., Wilmington, DE (US)

(21) Appl. No.: 18/849,787

(22) PCT Filed: Apr. 3, 2023
(86) PCT No.: PCT/US2023/017347

§ 371 Date: Sep. 23, 2024

(51) Int. Cl. H04B 7/04; H04B 7/06; H04W 72/044; H04W 74/0833

(52) U.S. Cl. CPC H04B 7/04013; H04B 7/06968; H04W 72/046; H04W 74/0833

(57) ABSTRACT

A WTRU may detect a reflected SSB transmission from a RIS. The reflected SSB is associated with an index. The WTRU may determine a source device of the reflected SSB transmission based on the index. For example, the WTRU may determine that the reflected SSB transmission was reflected by the RIS based on the index associated with the RIS. The WTRU may perform a random access procedure with a network device via the RIS based on the index. The SSB transmission may be associated with an SSB burst transmission comprising a plurality of SSB transmissions, where each of the plurality of SSB transmissions may be associated with the index. The plurality of SSB transmissions may comprise SSB transmissions reflected by the RIS and/or SSB transmissions not reflected by the RIS. The spatial state of the RIS may be maintained constant and/or may change during the SSB burst transmission.

### CROSS REFERENCE TO RELATED APPLICATIONS

This application claims the benefit of U.S. provisional application No. 63/328,897 filed on Apr. 8, 2022, and is incorporated by reference as if fully set forth herein.

### BACKGROUND

The present invention relates to the field of computing and communications and, more particularly, to methods, apparatus, systems, architectures and interfaces for computing and communications in an advanced or next generation wireless communication system, including communications carried out using a new radio and/or new radio (NR) access technology and communication systems. Such NR access and technology, which may also be referred to as 5G and/or 6G, etc., and/or other similar wireless communication systems and technology may include features and/or technologies for a reconfigurable intelligent surface (RIS). As described herein, a RIS may be capable of adapting to radio environment conditions. For example, a RIS may be capable of electronically controlling the propagation of radio frequency (RF) signals impinging on a surface of the RIS. NR downlink (DL) beam management BM aims at adjusting the transmission and reception point (TRP) transmission (Tx) beams and WTRU received (Rx) beams. One or more of the following may apply. A P1 procedure may be used to enable WTRU measurement on different TRP Tx beams, for example, to support the selection of TRP Tx beams/WTRU Rx beam(s). A P2 procedure may be used to enable WTRU measurement on different TRP Tx beams, e.g., to change inter/intra-TRP Tx beam(s). A P3 procedure may be used to enable WTRU measurement on the same TRP Tx beam, e.g., to change WTRU Rx beam (e.g., if the WTRU uses beamforming).

### SUMMARY

A system may be configured to perform reconfigurable intelligent surface (RIS) aided initial access. For example, the system may include a network node (e.g., gNB or TRP), a RIS, and one or more wireless transmit receive unit(s) (WTRU(s)). The network node may be configured to transmit configuration information to the RIS. For example, the configuration information may be configured to cause the RIS to reflect impinging signals (e.g., based on channel information). After configuring the RIS, the network node may transmit a synchronization block (SSB) towards the RIS. Based on the configuration information, the RIS may reflect the SSB transmitted by the network node. For example, the RIS may reflect the SSB towards a WTRU. In certain implementations, the configuration information transmitted to RIS may be specific to a given SSB transmission (e.g., or SSB transmission burst). In such an implementation, the network node may transmit multiple configuration information to the RIS, where each of the respective confirmation information is associated with a respective SSB transmission.

The WTRU may detect the reflected SSB. Based on the SSB, the WTRU may acquire the remaining system information (RMSI) and/or perform a random access procedure. After completing the random access procedure, the WTRU may enter a connected state. The SSB detected by the WTRU may be associated with an index. For example, the WTRU may determine a source detected SSB (e.g., the network node or the RIS) based on the index. Additionally or alternatively, the WTRU may use the index associated with the detected SSB to map one or more physical random access channel (PRACH) occasions.

A WTRU may detect a reflected SSB transmission from a RIS, wherein the reflected SSB is associated with an index. The index associated with the reflected SSB may be an SSB index or a candidate SSB index (e.g., an SSB occasion). The WTRU may determine that the reflected SSB transmission was reflected by the RIS based on the index associated with the reflected SSB transmission. For example, the WTRU may determine a source device of the reflected SSB transmission based on the index (e.g., whether the SSB transmission was reflected by the RIS or received directly from a network device). The WTRU may perform a random access procedure with a network device via the RIS based on the index.

In some examples, the WTRU may determine that the reflected SSB transmission was reflected by the RIS based on a determination that the index associated with the SSB transmission is not quasi collocated (QCL) with a candidate SSB index associated with the SSB transmission.

In some examples, the index associated with the reflected SSB may be a candidate SSB index (e.g., an SSB occasion). In such examples, the WTRU may determine that the reflected SSB transmission was reflected by the RIS based on a determination that the index associated with the SSB transmission is not quasi collocated (QCL) with a burst set index associated with the SSB transmission.

The SSB transmission may be associated with an SSB burst transmission comprising a plurality of SSB transmissions. Each of the plurality of SSB transmissions may be associated with the index. The plurality of SSB transmissions may comprise SSB transmissions reflected by the RIS and/or SSB transmissions not reflected by the RIS. In some examples, the spatial state of the RIS may be maintained constant during the SSB burst transmission.

The SSB burst transmission may comprise the reflected SSB transmission and/or a plurality of legacy SSB transmissions. The plurality of legacy SSB transmissions may not be reflected by the RIS. The SSB burst transmission may be transmitted according to a legacy SSB transmission pattern.

The WTRU may detect a second reflected SSB transmission from the reflected RIS. The second reflected SSB transmission may be associated with a different spatial beam than the reflected SSB transmission. The reflected SSB transmission may be associated with a first SSB transmission burst from the source device. The reflected SSB transmission and/or the second reflected SSB may be associated with a second SSB burst transmission from the source device.

The second reflected SSB transmission may be associated with the same index as the reflected SSB transmission.

The number of candidate SSB indices may be greater than a number of SSB indices.

The subset of the plurality of SSB transmissions of the SSB burst transmission may be reflected by the RIS at a plurality of different spatial states.

The WTRU may detect an un-reflected SSB transmission. The un-reflected SSB transmission may not be reflected by the RIS. The un-reflected SSB transmission may not be associated with a second SSB burst transmission comprising a plurality of SSB transmissions. The plurality of SSB transmissions of the SSB burst transmission may be reflected by the RIS.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example RIS-aided wireless system;

FIG. 3 illustrates an example 4-element RIS;

FIG. 4 illustrates an example associated with a passive RIS that may be capable of reflecting incident/impinging signals (e.g., beams) in multiple directions;

FIG. 5 illustrates another example associated with a RIS-aided wireless system;

FIG. 6 illustrates an example RIS-aided architecture;

FIGS. 7A, 7B, and 7C illustrate examples associated with a RIS-controller;

FIG. 8 illustrates an example associated with a RIS added initial access;

FIGS. 9-13 illustrate examples associated with RIS added initial access and/or backwards compatibility;

FIG. 14 illustrates an example procedure associated with determining the source (e.g., via the RIS-to-WTRU path or the gNB-to-WTRU) of a detected SSB;

FIG. 15 illustrates an example associated with RIS-aided SSB transmissions;

FIGS. 16A and 16B illustrate examples associated with multiple SSB transmissions;

FIGS. 17 and 18 illustrate examples associated with a SSB burst set transmissions; and

FIGS. 19 and 20 illustrate further examples associated with multiple SSB burst set transmissions.

### DETAILED DESCRIPTION

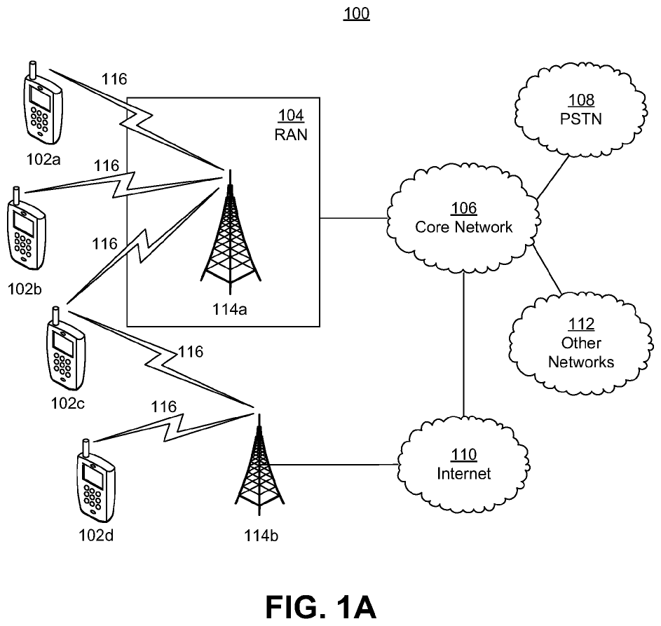

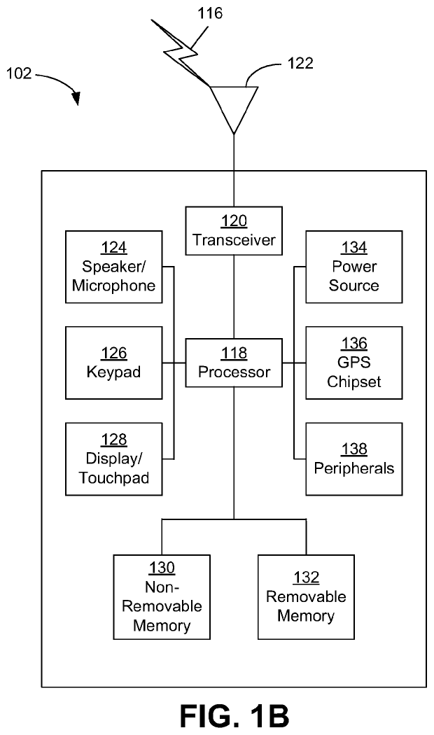

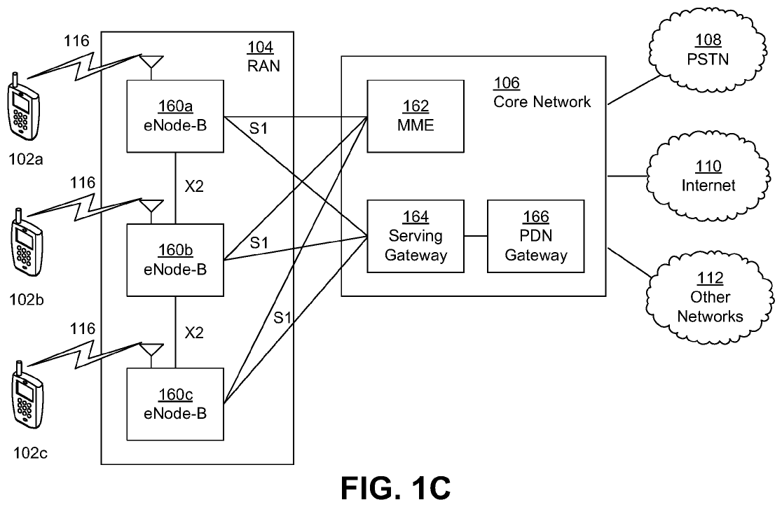

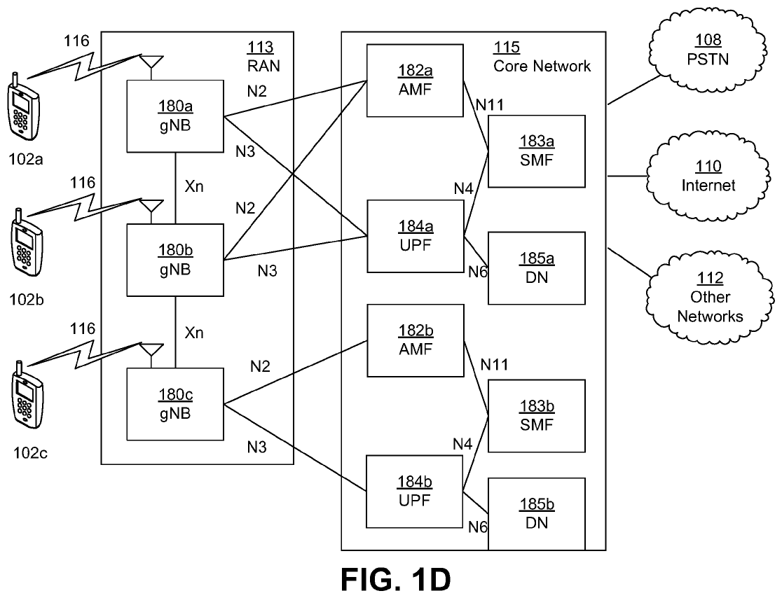

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

One or more of the following may occur during initial access. P1 (e.g., beam selection) procedures may focus on the initial acquisition (e.g., based on a synchronization signal block (SSB)) for a WTRU in the idle state. The SSB may include a primary synchronization signal (PSS), a secondary synchronization signal (SSS) and/or physical broadcast channel (PBCH). Periodic SSB beam sweeping may be implemented by the network (e.g., gNB) in a certain interval (e.g., the SSB periodicity may be 20, 40, 80, and/or 160 ms). Beam scanning may be implemented by the WTRU, for example, to determine the optimal receive beam. SSB in an SSB burst set may be multiplexed in the time domain.

For subsequent downlink transmissions (DL Tx(s)), the WTRU may assume that the receiving (Rx) beam used to acquire the SSB will be a suitable beam for the reception of subsequent downlink transmissions. The WTRU may use the Tx beam used to transmit a physical random access channel (PRACH) transmission. Beam-sweeping for SSB transmission may, for example, enable receiver-side beam-sweeping for the reception of uplink random-access transmissions and/or downlink beamforming for random-access responses. The P1 (e.g., beam selection) procedure may complete when the random-access procedure is completed.

One or more of the following may apply in certain initial access procedures (e.g., NR initial access procedures). In examples, a WTRU may search for an SSB and obtain the physical cell ID (PCI) and/or downlink (DL) synchronization. The WTRU may decode the master information block (MIB). The WTRU may obtain the configuration of the physical downlink control channel (PDCCH). The PDCCH may be used to obtain the remaining system information (RMSI). The control resource set (CORESET) #0 configuration for RMSI may be associated with an SSB in an SSB burst set. The WTRU may read the RMSI from system information block (SIB) #1 and decodes the public land mobile network (PLMN) ID, cell selection parameters, random access channel (RACH) parameters, etc. The WTRU may perform random access and obtain UL synchronization. The UL synchronization may include the timing advance (TA). The WTRU may establish a radio resource control (RRC) connection.

One or more of the following may apply for an SSB candidate index (e.g., in NR). A half frame may include SSBs. The first symbol indexes for candidate SSBs may be determined according to the sub-carrier spacing (SCS) of the SSBsIndex 0 may correspond to the first symbol of the first slot in the half frame. Lₘₐₓ may denote (e.g., in NR) the maximum number of SSB identifications (IDs) in an SSB burst set. L̅ₘₐₓ may denote the maximum candidate SSB index (e.g., or SSB occasion, SSB position). For example, the SSB ID may indicate the beam ID. For operation without shared spectrum channel access, an SSB index may be the same as a candidate SSB index (e.g., Lₘₓ=L̅ₘₐₓ). For operation with shared spectrum, L̅ₘₐₓ≥Lₘₐₓ. An example mapping of symbol indexes (e.g., NR symbol indexes) with the candidate SSB index may be shown in Table 1:

TABLE 1

| | SCS | Candidate SSB | |
|---|---|---|---|
| Case | [KHz] | indices | Range of n |
| A | 15 | {2, 8} + 14 · n | n = 0, 1 f_{c} ≤ 3 GHz |
| | | | n = 0, 1, 2, 3 f_{c} > 3 GHz |
| | | | n = 0, 1, 2, 3, 4 shared spectrum channel |
| | | | access |
| B | 30 | {4, 8, 16, 20} + | n = 0 f_{c} ≤ 3 GHz |
| | | 28 · n | n = 0, 1 f_{c} > 3 GHz |
| C | 30 | {2, 8} + 14 · n | n = 0, 1 f_{c} ≤ 3 GHz |
| | | | n = 0, 1, 2, 3 f_{c} > 3 GHz |
| | | | n = 0, 1, 2, 3, 4, 5, 6, 7, 8, 9. shared |
| | | | spectrum channel access |
| D | 120 | {4, 8, 16, 20} + | n = 0, 1, 2, 3, 5, 6, 7, 8, 10, 11, 12, 13, |
| | | 28 · n | 15, 16, 17, 18 |
| E | 240 | {8, 12, 16, 20, 32, | n = 0, 1, 2, 3, 5, 6, 7, 8. |
| | | 36, [symbol] + 56 · n | |
| F | 480 | {2, 9} + 14 · n | n = 0, 1, 2, 3, 4, 5, 6, 7, 8, 9, 10, 11, 12, |
| | | | 13, 14, 15, 16, 17, 18, 19, 20, 21, 22, |
| | | | 23, 24, 25, 26, 27, 28, 29, 30, |
| G | 960 | {2, 9} + 14 · n | n = 0, 1, 2, 3, 4, 5, 6, 7, 8, 9, 10, 11, 12, |
| | | | 13, 14, 15, 16, 17, 18, 19, 20, 21, 22, |
| | | | 23, 24, 25, 26, 27, 28, 29, 30, |

[symbol]

indicates data missing or illegible when filed

One or more of the following may apply for SSB mapping to PRACH occasions (e.g., in NR). A parameter, such as, ssB-perRACH-OccasionAndCB-PreamblesPerSSB may configure N SSB (SSB-per-rach-occasion), which may be associated with a PRACH occasion and the number of preambles that each SSB uses on each effective PRACH occasion (e.g., based on contention (CB-preambles-per-SSB)).

There may be two configurations associated with N. If N<1, one SSB may be mapped to 1/N continuous effective PRACH occasions; and/or if N≥1, N SSBs may be mapped to one PRACH occasion.

One or more of the following may apply for reconfigurable intelligent surfaces (RIS). RISs may create a smart propagation environment (e.g., for future wireless communication systems). The surfaces of a RIS may, for example, be capable of intelligently altering the radio environment (e.g., by electronically controlling the propagation of the incident/impinging signals in a programmable manner to improve the system performance). The introduction of RISs to wireless communication system may allow scattering in an environment to be controllable.

As described herein, a RIS may include one or more (e.g., a large number of) elements (e.g., sub-wavelength sized unit elements), which may be electronically controlled. In certain implementations, the RIS elements may include meta-surfaces and/or reflection-arrays. RIS elements may be closely-spaced, which may allow the RIS to operate as a scatterer (e.g., a smart scatterer). Each element may modify the properties of impinging signals (e.g., reflection, refraction and/or absorption). The RIS elements may be passive, active, and/or semi-active. For example, passive elements may passively reflect signals without amplification. For example, active elements may be capable of actively reflecting signals with amplification.

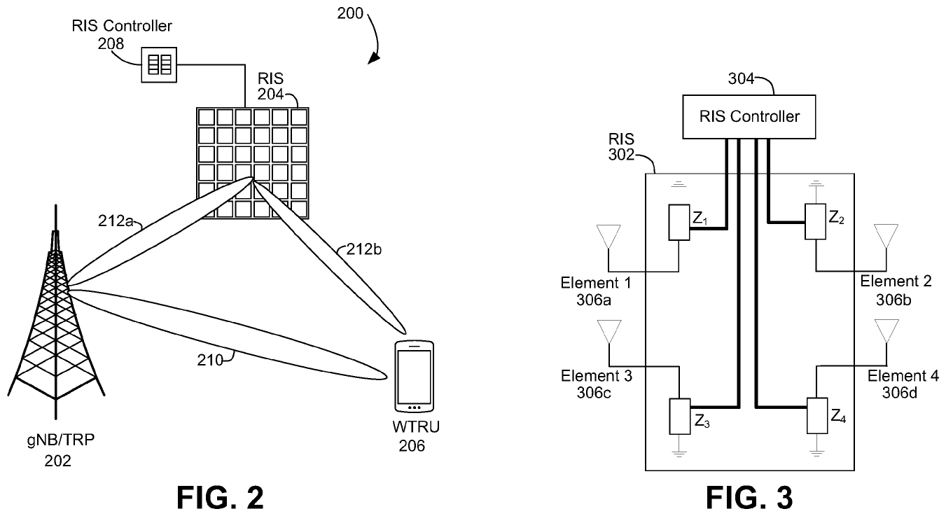

FIG. 2 illustrates an example RIS-aided wireless system 200. The RIS-aided wireless system 200 may include a transmitter 202 (e.g., gNB and/or TRP), a RIS 204 and a receiver 206 (e.g., WTRU). Referring to the example illustrated in FIG. 2, the RIS 208 may be located between the transmitter 202 and the receiver 206, where (e.g., in addition to the direct link 210 between the transmitter 202 and receiver 206) another link 212a-b exits between the two nodes through the RIS 204. Both links (e.g., the transmitter-receiver link 210 and the link 212a-b between the transmitter 202 and receiver 206 through the RIS 204), if controlled properly, may improve the overall system performance.

The RIS 204 may be controlled via a RIS controller 208, which may be integrated into the RIS 204 or separate from the RIS 204 (e.g., as shown in FIG. 2). The RIS controller 208 may be capable of independently controlling the elements of the RIS 204, for example, after receiving a specific control signal from the transmitter 202 (e.g., gNB and/or TRP), and/or receiver 206 (e.g., WTRU).

FIG. 3 illustrates an example 4-element RIS 302. The RIS controller 304 may be connected to the elements 306a-d (e.g., all elements) of the RIS 302. The RIS controller 304 may alter the phase-shifts of incident and/or impinging signals and route them towards a specific direction by adjusting the respective impedance (e.g., Z_{N}) of each element.

There may be multiple types of RISs 302, including, for example, passive RISs, active RISs, and/or semi active RISs. A passive RIS, for example, may include passive elements (e.g., diodes, transmission/delay lines, lumped circuits etc.) that can adjust the phase shift individually for each the RIS element or simultaneously for a group of the RIS elements. As described herein, a passive RIS may reflect impinging signals by adjusting the phase shifts and/or constructively superimposing and enhancing the received signals from different paths. Furthermore, e.g., due to the passive nature of the RIS elements, a passive RIS may use minimal power (e.g., nearly zero power). Semi-active or active RISs may be equipped with the power amplification phase adjustment capabilities for impinging signals. Referring to a semi-active RIS, for example, (e.g., herein also known as and referred to as a hybrid active-passive RIS), one or more active elements of the total RIS elements may facilitate additional application functionality. The one or more active elements may be capable of both amplification and phase adjustments. The remaining elements of the RIS may be passive that only provide phase adjustments. For example, the elements (e.g., all the elements) in an active RIS may be active elements that can provide amplification and phase gains.

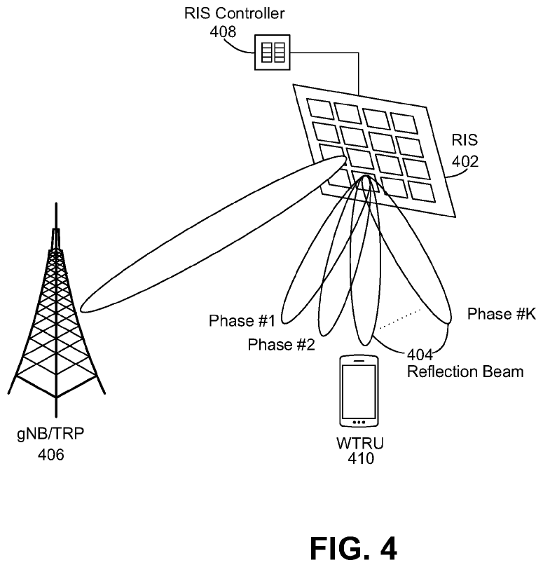

Referring to an implementation that includes a passive RIS, amplitude configurations may not be used in a beam selection process (e.g., a P1 procedure). Additionally or alternatively, the RIS-aided SSBs may be based on non-amplification tuning, such as reflection. In such implementations, the elements of the RIS may be controlled by a RIS controller, for example, to change the electromagnetic properties of the reflected signals (e.g., apply phase shifts). FIG. 4 illustrates an example associated with a passive RIS 402 that may be capable of reflecting incident/impinging signals 404 (e.g., beams) in multiple directions. As shown in FIG. 4, signals transmitted from a transmitter 406 (e.g., gNB and/or TRP) may be passively controlled with no amplification capabilities.

Referring to an implementation that includes an active RIS 402, the configuration information may be transmitted to the RIS 402 and/or RIS controller 408 (e.g., from the network). For example, the configuration information may include amplitude configurations, which may be used in the beam selection process. In such implementations, the RIS 402-aided SSBs may be actively reflected with amplification tuning, such as reflection. The elements of the RIS 402 may be controlled by the RIS controller 408, for example, to change the electromagnetic properties of the reflected signals (e.g., apply phase shifts).

In certain networks (e.g., NR), a WTRU 410 may perform initial access before the WTRU 410 enters the RRC connected state/mode for data reception and transmission. In the initial access stage, the WTRU 410 may detect the synchronization signal block (SSB) to obtain system information (SI), establish a beam-correspondence link, based on an SSB within a beam sweeping burst (e.g., SSB burst and/or burst set) transmitted from the network (e.g., gNB and/or TRP), and/or obtain frequency and/or timing synchronization. For example, the SSB burst set may cover some spatial areas with a set of beams according to pre-defined intervals (e.g., candidate SSB index).

A function of a RIS 402 may include reflecting the incident beams 404 (e.g., in a desired direction), such that coverage and reception quality is enhanced. If, for example, a RIS 402 implemented in a given wireless communication system, the WTRU 410 may detect SSBs from numerous radio propagation paths during initial access (e.g., the RIS-to-WTRU path, from gNB/TRP-WTRU path, and/or from both the RIS-to-WTRU path and gNB/TRP-WTRU path).

For example (e.g., for the mmWave or higher frequency ranges), the WTRU may be blocked by an obstruction, such that the WTRU is out of gNB coverage and the current initial access and the beam selection are unable to received/obtained.

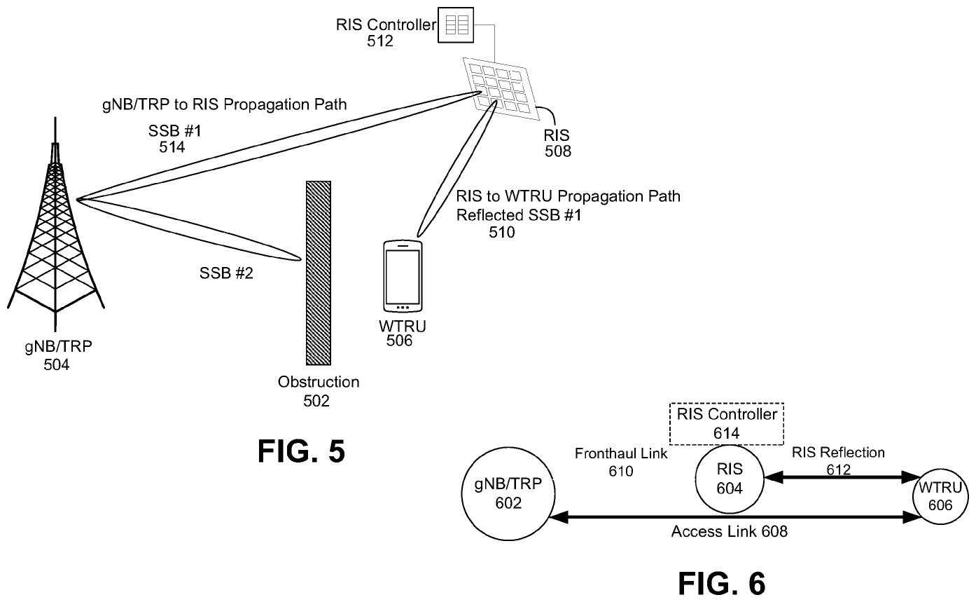

FIG. 5, for example, illustrates an example where obstruction 502 exists (e.g., between the gNB and/or TRP 504 and the WTRU 506). the WTRU 506 may be reached with assistance from a RIS 508. The WTRU 506 may perform initial access, for example, using RIS 508 assistance to achieve timing and frequency synchronization and/or initial beam selection. To provide assistance, however, the RIS 508 may be configured to reflect the SSB 510 in the proper spatial direction (e.g., such that the WTRU 506 can detect the SSB 510).

Additional SSBs may also be used, e.g., for RIS 508 to perform beam sweeping to enhance the coverage. Such signaling to enable RIS 508 assistance may not, however, be defined and/or provided. One or more of the techniques described herein may be used to enable RIS 508 assistance during initial access and/or may consider various radio propagation path (e.g., the RIS-to-WTRU path, from gNB/TRP-WTRU path, and/or from both the RIS-to-WTRU path and gNB/TRP-WTRU path).

Initial access may be performed with RIS 508 assistance (e.g., RIS 508-aided initial access). One or more of the following may apply, including, e.g., transmission of RIS 508-aided SSBs. A candidate SSB index may be greater than the SSB index. Extra candidate SSB indices may be used for SSB index repetition (e.g., towards the same RIS). Additionally or alternatively, multiple SSB indices may be used towards the same RIS 508, and RIS controller 512 may apply a given configuration at a candidate SSB index to reflect the SSB 514. Multiple SSB burst sets may be broadcast by the network (e.g., gNB/TRP), and one or more (e.g., some) of the burst sets used for the RIS 508. The WTRU 506 may determine RIS-to-WTRU or gNB/TRP-to-WTRU path based on the detected SSB within a burst set.

PRACH transmissions may be performed with RIS 508 assistance (e.g., RIS 508-aided PRACH). For example, one or more RIS 508-aided SSB and PRACH mapping rules may be provided.

One or more of the following may apply for an architecture associated with a RIS-aided system (e.g., to perform RIS-aided initial access). One or more radio links and/or radio propagation paths (e.g., among the gNB, RIS and/or WTRU) may be defined. As described herein, a RIS-aided system may be tiered system (e.g., a three-tier system, that includes a gNB/TRP, RIS and a WTRU(s)). For example, FIG. 6 illustrates an example RIS-aided architecture that includes a gNB/TRP 602, RIS 604, and a WTRU(s) 606. As shown in FIG. 6, multiple (e.g., two paths) may exist between the gNB/TRP 602 and the WTRU 606. For example, a first path may be a path that does not include the RIS 604 (e.g., a direct path 608 from the gNB/TRP 602 and the WTRU 606), and a second path 610-612 may be a path that includes the RIS 604 (e.g., a reflection path 612 between the RIS 604 and the WTRU 606). For example, the reflection path 612 between the RIS 604 and the WTRU 606 may be controlled, for example, by the network (e.g., the gNB/TRP 602) via the RIS controller 614, as illustrated in FIG. 6.

As described herein, one or more radio links may be defined. A first link may include the link between the network (e.g., gNB/TRP 602) and the RIS 604, which may be referred to as the fronthaul link 610. A second link may include the link between the network (e.g., gNB/TRP 602) and the WTRU 606, which may be referred to as the access link 608. One or more paths may also be defined. In examples, a first path may include the path between the gNB/TRP 602 and the RIS 604 (e.g., the gNB-to-RIS path). A second path may include the path between the gNB/TRP 602 and the WTRU 606 (e.g., the gNB/TRP-to-WTRU path). A third path may include the path between the RIS and WTRU (e.g., the RIS-to-WTRU path).

One or more of the following may apply for the fronthaul link 610. The fronthaul link 610 may represent a control link between the gNB/TRP 602 and the RIS 604 and/or RIS controller 614. The fronthaul link 610 may carry control signals between the gNB and/or TRP 602 and the RIS controller 614 (e.g., in both directions). For example, the control signals carried by the fronthaul link 610 may be used to configure the RIS controller 614 in the gNB/TRP-RIS direction. The control signals carried by the fronthaul link 610 may Additionally or alternatively, be used to send feedback and configuration information in the RIS-gNB/TRP direction.

One or more of the following may apply for the access link 608. The access link 608 may be distinguished by the propagation paths (e.g., the radio propagation paths) between the gNB/TRP 602 and the WTRU 606. As described herein, the path between the gNB/TRP 602 and the WTRU 606 that does not include RIS 604 assistance may be denoted as the gNB/TRP-to-WTRU path. Similarly, the path between the gNB/TRP 602 and the WTRU 606 that includes RIS 604 assistance (e.g., the reflection path from the RIS 604 to the WTRU 606) may be denoted as the RIS-to-WTRU path. The access link may carry UL and DL data and control channels (e.g., PDCCH, PDSCH, PUCCH and/or PUSCH) from the gNB/TRP 602 and/or to the WTRU 606.

As described herein, a RIS controller 614 may be used to perform RIS 604 assistance. One or more of the following may apply. The RIS-WTRU reflected path 612 may be controlled by the system via the RIS controller 614. For example, the RIS controller 614 may receive control signals, e.g., through the gNB/TRP 602-to-RIS 604 control path. For example, a RIS controller 614 may be implemented by a mobile terminal (MT), a distribution unit (DU), and/or a RAN intelligent controller (RIC).

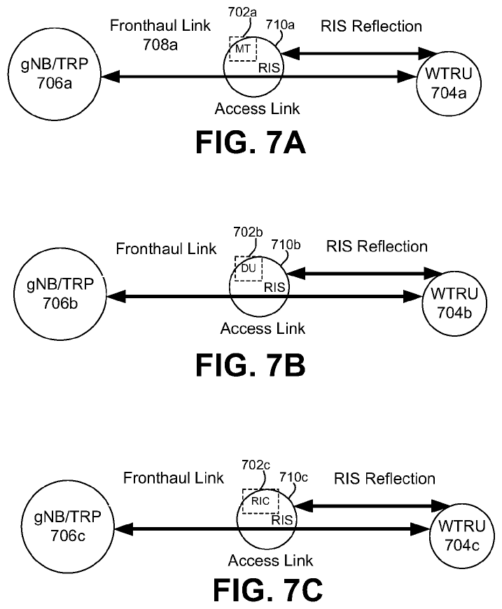

FIGS. 7A, 7B, and 7C illustrate examples associated with a RIS-controller. If a RIS controller is implemented by a MT 702a (e.g., an MT RIS controller), one or more of the following may apply. The MT 702a based RIS controller may fulfill the role of a WTRU 704a, as seen in FIG. 7A, where the MT 702a is connected to the gNB/TRP 706a, e.g., through the fronthaul link 708a. The gNB/TRP 706a may have additional functionalities, for example, to support RIS 710a-based MT 702a operations. Each RIS controller may be connected to multiple gNBs/TRPs 706a (e.g., having RIS-based functionalities). For example, RIS controller may be configured for dual-connectivity (e.g., NR dual-connectivity). Additionally or alternatively, each RIS controller may be connected to multiple RISs 710a.

If a RIS controller is implemented by a DU 702b (e.g., a DU RIS controller), one or more of the following may apply. The DU 702b based RIS controller may behave as a network node (e.g., a gNB/TRP 706b), as shown in FIG. 7B. As shown in FIG. 7B, the DU 702b based RIS controller type may operate as a gNB/TRP 706b with split protocol stack. For example, a DU 702b based RIS controller may be employed with active RIS 710b arrays.

If a RIS controller is implemented by an RIC 702c (e.g., an RIC-based RIS controller), one or more of the following may apply. An example RIC 702c-based RIS controller is illustrated in FIG. 7C. As shown in FIG. 7C, the RIC 702c-based RIS controller may include a processing unit that, for example, incorporates a one or more applications that may support RIS control functionalities. For example, the RIC 702c-based RIS controller may have near real-time (near-RT) RIC 702c control functionalities. The RIC 702c-based controller may implement certain procedures for hosting configurations settings for the RIS 710c array and/or exchanging control procedures with the gNB/TRP 706c (e.g., via universal software radio peripheral (USRP) connectivity). The gNB/TRP 706c may also include additional functionalities to support RIC 702c-based RIS controller.

As described herein, one or more RIS types may be used to provide assistance during initial access. In examples, certain implementations, information relating to the type of RIS (e.g., RIS capability, and/or class) that provides assistance may be signaled to the gNB/TRP (e.g., so the gNB/TRP knows the capabilities of the RIS before the RIS turns on). Based on the RIS type that provides assistance, the network may configure the RIS controller to set up the RIS configuration. Based on the RIS type that provides assistance, the RIS controller may configure and/or control the RIS array and/or elements according to the network configuration. The network (e.g., via a gNB) may control the RIS controller based on the received information relating to the type of RIS and/or RIS capabilities. Additionally or alternatively, the RIS-controller may report its capabilities, such as its processing time, (e.g., the time between receiving the control and/or configuration information and configuring the RIS with the network). The RIS controller may determine or obtain the TDD and/or FDD and/or slot format indication (SFI) associated with a group of WTRUs. The RIS may use this information to reflect incident and/or impinging signals appropriately, e.g., for DL, UL, and/or flexible slot structure.

As described herein, RIS-aided initial access may be performed. One or more of the following may apply. A network node (e.g., gNB/TRP) may be associated with K number of beams (e.g., SSB). The beams may be associated with default and/or initial RIS settings, e.g., for when a WTRU performs initial access. As described herein, a RIS-aided SSB may refer to a SSB reflected and/or beamformed by a RIS.

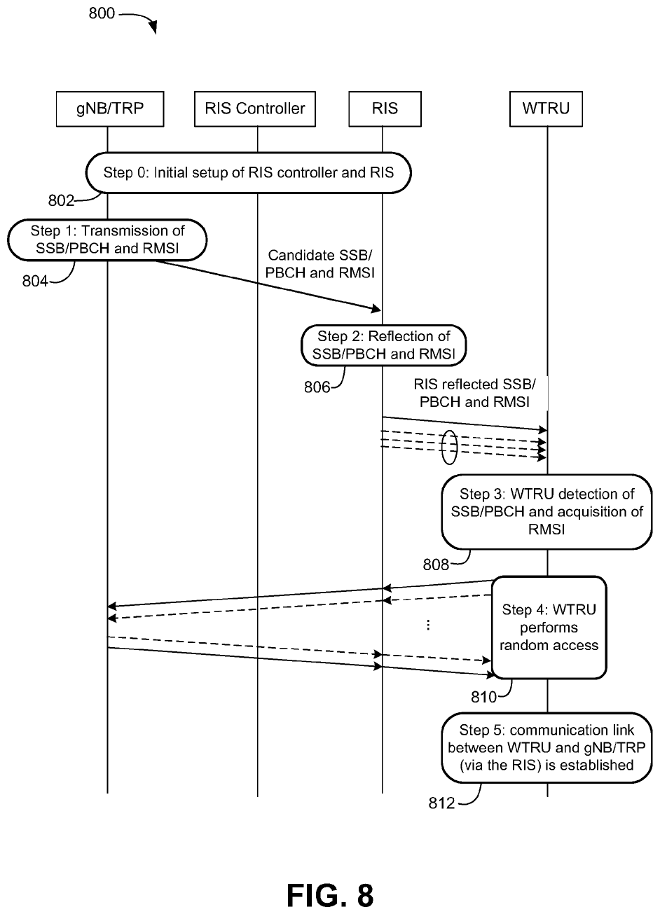

FIG. 8 illustrates an example associated with a RIS added initial access procedure 800. One or more of the following may apply regarding initial access. An initial setup of the RIS controller and RIS may be performed. At 802, when the RIS is initially deployed or powered on, the RIS controller may perform a synchronization procedure. In examples, the synchronization procedure may obtain time and frequency synchronization with a gNB/TRP, acquire the MIB and SIB, and/or complete the beam pairing with the gNB/TRP. Additionally or alternatively, time and frequency synchronization with the gNB/TRP may be set (e.g., manual setting) at deployment and/or via an operator's RIS deployment setup procedure between the gNB/TRP and the RIS. Once the initial setup is completed, the RIS-controller may be able to receive RIS control messages from the gNB/TRP. For example, if the type of RIS-controller is an MT RIS-controller, the MT RIS-controller may enter the RRC connected state and/or may receive RIS control messages.

At 804, The gNB/TRP may transmit the SSB and/or RMSI according to a defined RIS-aided SSB transmission scheme (e.g., as further described herein). If, for example, a WTRU is out of the gNB/TRP's coverage (e.g., due to an obstruction), the WTRU may not receive the SSB and/or RMSI transmitted directly by the gNB/TRP.

At 806, the RIS may reflect incoming and/or incident SSB and/or RMSI according to specific RIS-aided SSB transmission schemes used in the system as described herein.

At 808, the WTRU may perform cell search procedures, detect the SSB reflected by RIS, and/or acquire the RMSI. At 810, the WTRU may perform a random access procedure. Based on the detected candidate SSB index and/or the corresponding association, for example, the WTRU may determine the relevant RACH resources and/or RACH preamble indices (e.g., the subset of RACH resources and/or the subset of RACH preamble indices).

At 812, after the random access procedure completes, a communication link between the WTRU and the gNB (via the RIS) may be established. The WTRU may receive an RRC configuration and/or may enter an RRC connected state.

Referring to the example illustrated in FIG. 8, certain downlink sync signals (e.g., SSB) and the RMSI may be detected by a WTRU even if, for example, the WTRU is out of gNB coverage (e.g., blocked by an obstruction) (e.g., as seen at 808). Even if the WTRU is in network coverage (e.g., no obstruction exists), RIS assistance may allow the WTRU to detect the SSB and/or RMSI with better quality (e.g., as the RIS may boost the signals).

RIS-aided SSB transmission and/or detection may be performed (e.g., at 802). For example, the gNB/TRP may transmit SSB/PBCH and/or RMSI candidates to the RIS. If a WTRU is in gNB/TRP coverage, WTRU may be synchronized with the SSB transmitted from a gNB/TRP, for example, without the aid of a RIS (e.g., considering backward compatibility). The WTRU may perform a P1 procedure, for example, based on the SSB received from the gNB. If the RIS configuration is different in different SSB transmission occasions, the P1 procedure may be impacted (e.g., negatively impacted). For example, the WTRU may receive an SSB (e.g., ID #2) from the gNB on a first SSB transmission occasion. In the next SSB transmission occasion, the RIS may reflect the SSB (ID #2) differently, which may cause the WTRU Rx beam tuning to be different (e.g., different from the previous SSB transmission occasion).

One or more of the following may be used to support backward compatibility for certain initial access procedures (e.g., NR legacy WTRU with RIS aid initial access). A RIS may be kept in a (e.g., one) default spatial state (e.g., a spatial direction with a specific beam width which can be controlled and configured by RIS controller) during an SSB occasion (e.g., candidate SSB index/position). The RIS configuration may be the same on an SSB occasion, for example, such that there is no need for dynamic configuration for reflecting the incident SSB. A number of SSB indexes may be equal to legacy values (e.g., A, B, C, D, E, F and G, as listed in Table 1). That is, a legacy SSB transmission pattern may be maintained.

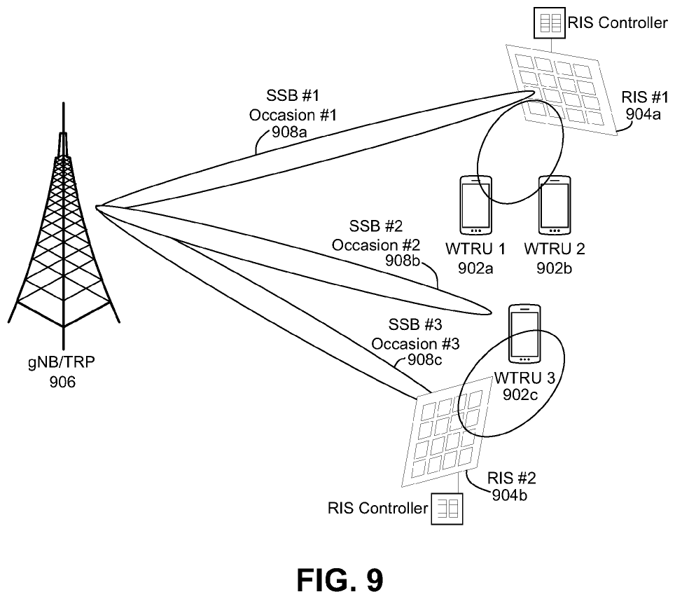

FIGS. 9-13 illustrate examples associated with RIS added initial access and/or backwards compatibility As shown in FIG. 9, such an implementation may be applied for a WTRU that is out of gNB/TRP coverage (e.g., without RIS assistance), for example, as shown by WTRU1 902a and WTRU2 902b. A WTRU may assume that an SSB has transmitted according to a certain pattern (e.g., the pattern used in NR). Referring again to FIG. 9, WTRU1 902a and WTRU2 902b may be assisted by RIS #1 904a, and WTRU3 902c may be able to receive the link 908a from both gNB/TRP 906 and RIS #2 904b. WTRU3 902c shown in FIG. 9 may detect different SSB (e.g., SSB #2 908b and SSB #3 908c as shown in FIG. 9) at different SSB occasions (e.g., candidate SSB index and/or position). For example, an SSB (e.g., a beam) in an SSB burst set may be time division multiplexed (TDM).

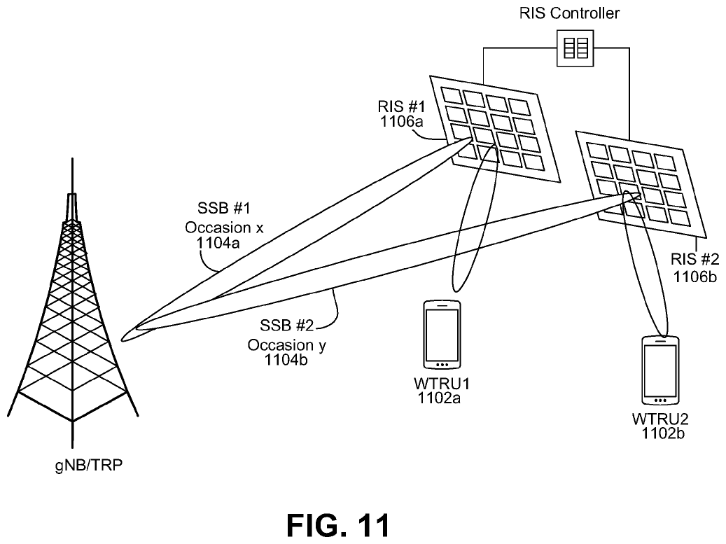

One or more (e.g., multiple) SSBs 908a-c may be forwarded to one or more (e.g., multiple) RISs 904a-b that are not colocated (e.g., as shown in FIG. 9) or colocated (e.g., as shown in FIG. 11). Referring now to FIG. 11, WTRU1 1102a may detect SSB #1 1104a at an SSB occasion (e.g., candidate SSB index/position) x reflected by RIS #1 1106a, and WTRU2 1102b may detect SSB #2 1104b at SSB occasion y reflected by RIS #2 1106b.

In certain implementations (e.g., NR), a WTRU may assume that transmission of SSB (e.g., in a burst set) in a half frame starts from the first symbol of the first slot in the half-frame. For a serving cell, the WTRU may assume that the periodicity is the same as the periodicity of half frames for the receptions of SSBs and that the duration of the burst set is within a half frame. Additionally, or alternatively, the number of SSB indexes may be equal to the number of SSB occasions (e.g., candidate SSB index/position) in an SSB burst set. If the number of SSB indexes are equal to the number of SSB occasions in an SSB burst set, the WTRU may obtain the timing and frequency synchronization information. In examples, the WTRU may obtain the timing and frequency synchronization information from the SSB index and/or candidate SSB index (e.g., after the WTRU successfully detects an SSB in an SSB burst set). In examples, the WTRU may obtain the cell ID from PSS and/or SSS. In examples, the WTRU may decode PBCH payload and/or fetch SSB index.

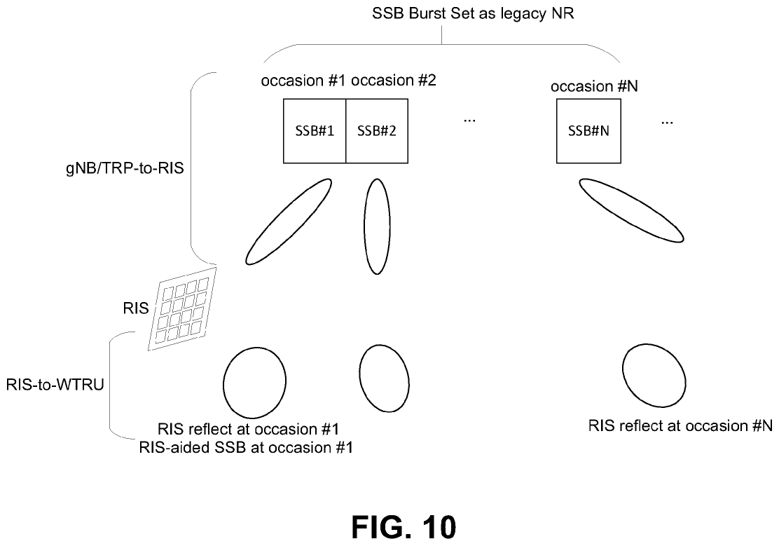

The WTRU may obtain the timing synchronization by mapping the SSB index with the candidate SSB index to determine the camping cell slot and/or frame timing without any ambiguity. Additionally or alternatively, the quasi-colocation (QCL) assumption may be based on the QCL assumption in gNB/TRP-to-RIS path, for example, as the reflected beam in the RIS-to-WTRU path may be associated with a one-to-one mapping relationship with the beam in gNB/TRP-to-RIS path (e.g., as shown in FIG. 10).

As described herein, backwards compatibility support for certain initial access procedures (e.g., NR legacy WTRUs with RIS-aided initial access) may be provided. In certain implementations, for example, support of a RIS that performs SSB beam sweeping (e.g., by using a SSB repetition technique) may be provided. One or more of the following may apply. For example, a RIS may be kept in a (e.g., one) given state (e.g., a default spatial state associated with a spatial direction and/or a specific beam width) during a given SSB transmission (e.g., occasion and/or candidate SSB index and/or position), as described herein. SSB transmission may be repeated one or more (e.g., multiple) times, for example, at different occasions (e.g., candidate SSB index and/or position).

The RIS may determine (e.g., assume) that a (e.g., each) repeated SSB is associated with a similar (e.g., the same) quasi-colocation (QCL) assumption as the gNB-to-RIS path. For example, a QCL assumption may (e.g., only) be valid for the gNB/TRP-to-RIS path. In certain implementations, the RIS may not determine (e.g., assume) that QCL for SSB repetitions are the same, for example, as the RIS controller may configure repeated SSB transmission (e.g., SSB transmissions in the same spatial directional on the gNB/TRP-to-RIS path) on different RIS-to-WTRU paths. In certain implementations, however, the WTRU may determine (e.g., assume) that the QCL for SSB repetitions are the same based on the detected SSB index (e.g., as the QCL source reference signal may be the detected SSB during initial access).

The network (e.g., gNB) may configure the RIS controller with the relevant timing to reflect the SSB during an SSB transmission occasion. If the network configures the RIS with the relevant timing, repeated SSBs may be transmitted towards the same RIS (e.g., if the RIS is stationary). Moreover, if the network configures the RIS with the relevant timing, the RIS controller may configure and/or control the RIS to reflect the SSB in one or more (e.g., various) spatial directions during the different SSB transmission occasions.

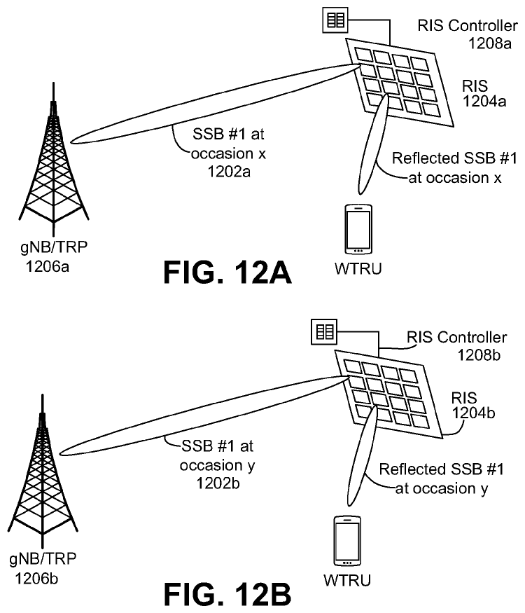

FIGS. 12A and 12B illustrate examples associated with multiple SSB transmission to a RIS that use a similar (e.g., the same) SSB index. As shown in FIG. 12A, SSB #1 1202a may be reflected in a spatial direction at an SSB occasion x. As shown in FIG. 12B, SSB #1 1202b may reflected in another spatial direction on another SSB occasion y. If, for example, multiple SSBs 1202a-b are transmitted toward the same RIS 1204a-b, the multiple SSBs 1202a-b may be transmitted with a similar (e.g., the same) SSB index (e.g., as illustrated in FIGS. 12A and 12B). For example, the multiple SSB transmissions 1202a-b are quasi co-located (QCLed) from gNB/TRP 1206a-b-to-RIS 1204a-b. As described herein, SSB 1202a-b repetition (e.g., as illustrated in FIGS. 12A and 12B) may refer to situation when the same SSB index is transmitted for more than one SSB occasion in an SSB burst set. The network may configure the RIS controller 1208a-b to set up the RIS configuration, and the RIS controller 1208a-b may configure the RIS 1204a-b for the repeated SSB beams 1202a-b, for example, in different directions. In certain implementations, beam sweeping may be performed from a RIS 1204a-b.

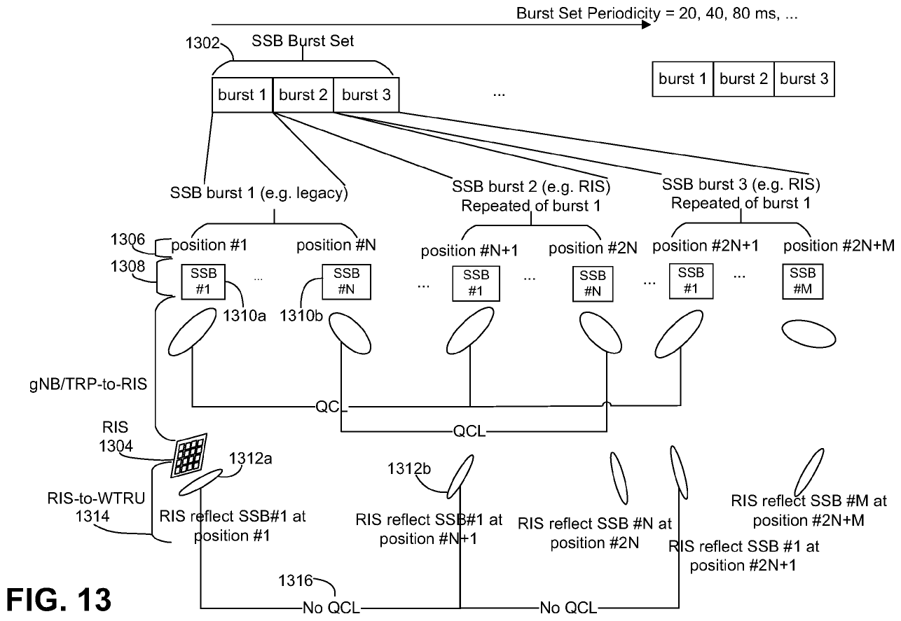

FIG. 13 illustrates an example associated with a single SSB burst set 1302 with SSB repetition, where the SSBs are reflected by a RIS 1304. To support SSB repetition, for example, as shown in FIG. 13, the number of transmitting SSB occasions 1306 (e.g., the number of candidate SSB indices/positions) may be greater than the number of SSB index(es) 1308. If the number of transmitting SSB occasions 1306 is greater than the number of SSB index(es) 1308, repeated SSBs or SSB bursts in the same SSB burst set 1302 may be forwarded to the same RIS 1304.

In examples, although a QCL assumption may be valid for repeated SSBs toward the same RIS for gNB/TRP-to-RIS path, the Rx beam may not be the same for WTRU in RIS-to-WTRU path (e.g., if the RIS controller configures RIS to perform SSB beam sweeping). For example, the RIS may switch the SSB beam to a different spatial direction at the different candidate SSB index (e.g., as shown in FIGS. 12A and 12B).

In examples, the parameter N_{QCL}^{SSB} or ssb-PositionQCL may be used (e.g., re-used) to define a range of SSBs that are determined (e.g., assumed) to have the same Rx beam for a WTRU. For example, the value of mod(ι̅, N_{QCL}^{SSB}) or mod(N_{DM-RS}^{PBCH}, N_{QCL}^{SSB}) may also indicate the QCL among SSB (e.g., as in NR-U), where ι̅ is the candidate SSB index and N_{DM-RS}^{PBCH} is an index of a DM-RS sequence transmitted in a PBCH of a corresponding SSB. If a WTRU determines (e.g., assumes) that the QCL is the same for the SSBs (e.g., all the SSBs) associated with a gNB-to-RIS path, the RIS controller may configure the RIS to reflect the QCLed SSB associated with the gNB/TRP-to-RIS path to a specific spatial direction on the RIS-to-WTRU path.

Table 2 illustrates an example relationship between the candidate SSB index, the SSB index, and the N_{QCL}^{SSB} (e.g., for SSB repetition). As shown in Table 2 and FIG. 13, it may be assumed that N_{QCL}^{SSB}=N=4 and that the candidate SSB indices ι̅ range is from 0 to 2×N+M=10−1=9 when M=2. As shown in Table 2, the repeated SSB may be the candidate SSB index from ι̅=4 to ι̅=9. In addition, the SSB shift value defined as

$$⌊ \frac{\overline{ι}}{{N}_{QCL}^{SSB}} ⌋$$

may be indicated in PBCH payload (e.g., MIB) as part of the candidate SSB index. A WTRU may use the detected candidate SSB index to obtain the timing synchronization (e.g., without ambiguities).

TABLE 2

| | | | | | | | | | | |
|---|---|---|---|---|---|---|---|---|---|---|
| Candidate SSB Index (ι̅) | 0 | 1 | 2 | 3 | 4 | 5 | 6 | 7 | 8 | 9 |
| L̅ₘₐₓ = 10 | | | | | | | | | | |
| SSB Index, N_{QCL}^{SSB} = 4 | 1 | 2 | 3 | 4 | 1 | 2 | 3 | 4 | 1 | 2 |
| $SSB value = ⌊ \frac{\overline{ι}}{{N}_{QCL}^{SSB}} ⌋$ | 0 | 0 | 0 | 0 | 1 | 1 | 1 | 1 | 2 | 2 |
| Reflected SSB index by RIS | 1 | 2 | 3 | 4 | 1 | 2 | 3 | 4 | 1 | 2 |

If a WTRU detects an SSB during initial access, the reception path from gNB/TRP-to-WTRU and/or RIS-to-WTRU may be transparent to WTRU. In certain implementations, a RIS may be proximate (e.g., closely located) to the WTRU. When proximate to the RIS, the WTRU may detect the SSB via the RIS (e.g., with better received power). In such an example, however, the effective propagation delay may increase. For example, the effective propagation delay may be equal to the propagation delay associated with the gNB/TRP-to-RIS path plus the propagation delay associated with the RIS-to-WTRU path.

In certain implementations, the candidate SSB index may be used for the determination when a detected SSB is received via a RIS or from the gNB/TRP (e.g., via the gNB/TRP-to-WTRU path). For example, the WTRU may perform a test (e.g., a hypothesis test) to determine whether the detected SSB is received from the RIS or from the gNB. For example, we assume that the detected candidate SSB index denotes ι̅. For example, ι̅≥N_{QCL}^{SSB} and the SSB ι̅ is QCLed with the candidate ι̅−N_{QCL}^{SSB}, the WTRU may determine that the detected SSB is received via the gNB/TRP-to-WTRU path. Otherwise, the WTRU may determine that the detected SSB is received via the RIS-to-WTRU path (e.g., as the RIS performs SSB beam sweeping and/or the spatial direction at the candidate SSB index ι̅(ι̅≥N_{QCL}^{SSB}) and the spatial direction at the candidate SSB index ι̅−N_{QCL}^{SSB} are different).

Referring to FIG. 13, the SSB index (e.g., ι̅=#1) may be repeated at the candidate SSB index #1 1310a or #N 1310b, respectively, and the RIS 1304 may reflect the SSB index #1 1310a at the candidate SSB index #1 1312a and #N 1312b with different spatial directions (e.g., or phase-shifts). The same SSB index #1 1310a may be transmitted at the candidate SSB index #1 1312a and #N 1312b. If the WTRU determine that the QCL assumption is valid between candidate SSB index #1 and #N, then the WTRU may determine that the SSB (e.g., ι̅=#1) was transmitted via the gNB/TRP-to-WTRU path. If the WTRU determines that the QCL assumption 1316 is not valid between the candidate SSB index #1 1312a and #N 1312b, then the WTRU may determines that the SSB was transmitted via the RIS-to-WTRU path 1314. Certain advantages may exist if the WTRU knows whether a given SSB is received via the gNB/TRP-to-WTRU path or the RIS-to-WTRU path 1314.

If a WTRU determines that a detected SSB is received via the RIS-to-WTRU path, the WTRU may proceed with the QCL assumption for the gNB/TRP-to-RIS path (e.g., for a PDCCH in CORESET #0 search space (SS) indicated by PBCH the payload and/or for the PDSCH for SI/RMSI scheduled by PDCCH in CORESET #0 search space). Irrespective of the CORESET #0 multiplexing pattern (e.g., TDM, FDM, hybrid, etc.), the QCL assumption may be valid, for example, because the source reference signal is the detected SSB of an SSB occasion during initial access.

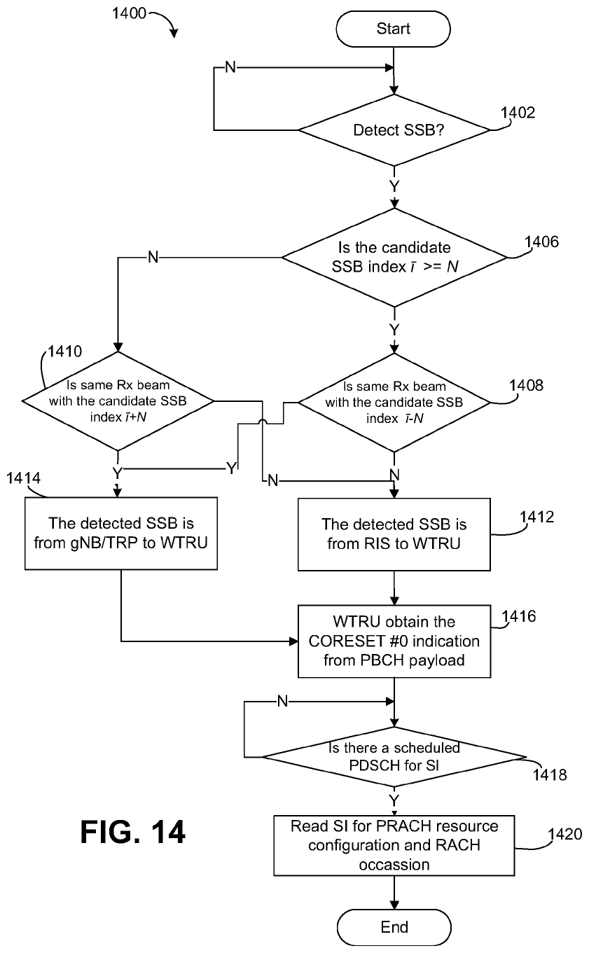

FIG. 14 illustrates an example procedure 1400 associated with determining the source (e.g., via the RIS-to-WTRU path or the gNB-to-WTRU path) of a detected SSB. At 1402, the WTRU may determine whether it has detected an SSB (e.g., an SSB transmission). If the WTRU does not detect an SSB, the WTRU will continue to monitor for an SSB. However, when the WTRU detects an SSB at 1406, the WTRU will determine if the candidate SSB index ι̅>=N. If the WTRU determines that the candidate SSB index is ι̅>=N at 1406, the WTRU may determine whether the receive beam is the same with the candidate SSB index ι̅−N, at 1408. If the WTRU determines that the Rx beam is not the same with the candidate SSB index ι̅−N at 1408, the WTRU may determine that the detected SSB was transmitted via RIS-to-WTRU path at 1412. However, if the WTRU determines that the Rx beam is the same with the candidate SSB index ι̅−N at 1408, the WTRU may determine that the detected SSB was transmitted via gNB/TRP-to-WTRU path at 1414.

If the WTRU determines that the candidate SSB index is not ι̅>=N at 1406, the WTRU may determine whether the Rx beam is the same with the candidate SSB index ι̅+N, at 1410. If the WTRU determines that the Rx beam is the same as the candidate SSB index ι̅+N at 1410, then the WTRU may determine that the detected SSB was transmitted via gNB/TRP-to-WTRU path at 1414. However, if the WTRU determines that the Rx beam is not the same as the candidate SSB index ι̅+N, then the WTRU may determine that the detected SSB was transmitted via the RIS-to-WTRU path at 1412.

After the WTRU determines whether the SSB transmission was transmitted via the RIS-to-WTRU path at 1412 or via the gNB/TRP-to-WTRU path at 1414, the WTRU may obtain the CORESET #0 indication from PBCH payload of the SSB transmission at 1416. At 1418, the WTRU may determine whether there is a scheduled PDSCH for SI at 1418. If the WTRU determines that there is a scheduled PDSCH for SI at 1418, the WTRU may read SI for the PRACH resource configuration and/or the RACH occasion at 1420.

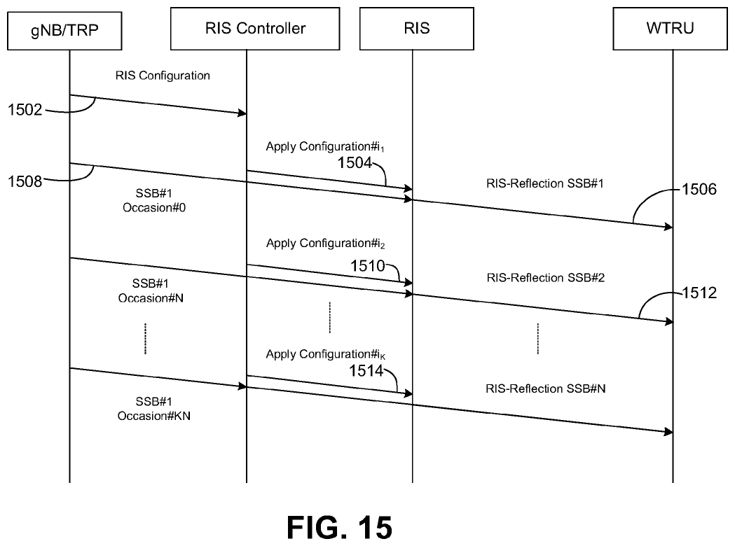

FIG. 15 illustrates an example associated with RIS-aided SSB transmissions. One or more of the following may apply. In examples, at 1502, a gNB/TRP may configure the RIS controller (e.g., to control the RIS) prior to an SSB transmission. For example, the gNB configuration may include K different RIS configurations. For example, the RIS controller may configure the RIS for repeated SSB beams at different times (e.g., candidate SSB index) with a different configuration At 1504, the RIS controller may apply configuration #1 for an SSB #1 occurring at occasion #0. For example, at 1506 configuration #1 may reflect SSB #1 in one spatial direction. At 1508, SSB #1 may be transmitted again, e.g., in the next occasion, where a different RIS configuration is applied by the RIS at 1510, such that SSB #1 is reflected in a different spatial direction at 1512. Configurations may be applied in this manner (as shown at 1514) until all K RIS configurations are accounted for.

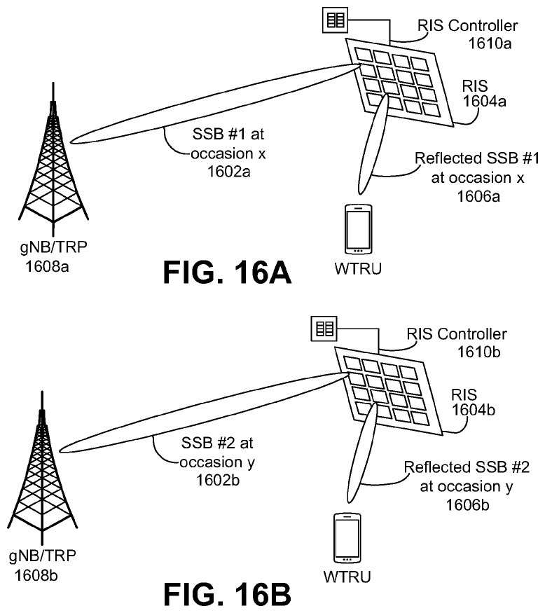

RIS-aided SSB detection may be performed. One or more of the following may apply. FIGS. 16A and 16B illustrate examples of multiple SSBs 1602a-b associated with different SSB indexes that may be transmitted toward a RIS 1604a-b. Referring to the example illustrated in FIG. 16A, SSB #1 1602a may be reflected in a spatial direction at an SSB occasion x at 1606a. Referring to the example illustrated in FIG. 16B, SSB #2 1602b may be reflected in another spatial direction on another SSB occasion y at 1606b.

A gNB may transmit extra SSB bursts, for example, in the same SSB burst set, which may enable the RIS to perform SSB beam switching. One or more (e.g., multiple) SSB(s) with different SSB indices may be transmitted towards the same RIS. The RIS may be configured in a (e.g., one) default spatial state (e.g., a spatial direction with a specific beam width) during a given SSB occasion (e.g., candidate SSB index/position), as described herein. For example, a number (e.g., the total number) of the candidate SSB index L̅ₘₐₓ may be equal to the total number of SSB index Lₘₐₓ, e.g., L̅ₘₐₓ=Lₘₐₓ without the use of shared spectrum (e.g., licensed band).

As shown in FIGS. 16A and 16B, one or more (e.g., multiple) SSBs that are associated with different SSB indexes (e.g., #1 1602a and #2 1602b) and occasions may be transmitted toward the same RIS 1604a-b. In such implementations, the RIS controller 1610a-b may configure the RIS 1604a-b to reflect (e.g., or beamform) incident SSBs at the corresponding SSB occasion.

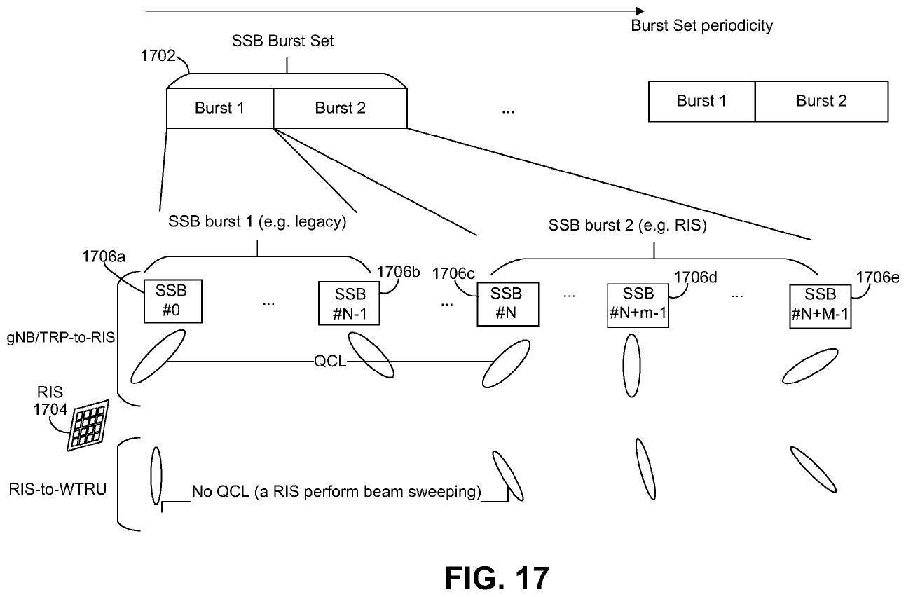

In certain implementations, the total number of the candidate SSB indexes L̅ₘₐₓ in an SSB burst set may be equal to N+M. The total SSB index Lₘₐₓ may, additionally or alternatively, be equal to N+M. A given SSB burst set may be partitioned (e.g., into two SSB bursts). In a first SSB burst partition, the candidate SSB index ι̅ may range from 0 to N−1, while the remaining candidate SSB indexes for a second partition (e.g., as shown in FIG. 17).

FIG. 17 illustrates an example associated with a single SSB burst set 1702 that includes extra SSB bursts. As shown in FIG. 17, the candidate SSB index ι̅=N+m−1 and ι̅=N may be used for the same RIS 1704. Although in certain implementations (e.g., in NR) different SSB indices 1706a-e may indicate different beams, an SSB index 1706a-e ambiguity may not exist for a WTRU detecting the SSB because, as shown in FIG. 17, each candidate SSB index may be mapped to a unique SSB index 1706a-e in an SSB burst set 1702. The WTRU may not be concerned about whether the SSB index i=N+m−1 and SSB index i=N are QCLed (e.g., because RIS controller may configure RIS to reflect (or beamform) SSB index i=N+m−1 and SSB index i=N in different spatial directions).

The WTRU may determine the source of a detected SSB (e.g., RIS-to-WTRU path, gNB/TRP-to-WTRU path or direct path, etc.) based on a candidate SSB index or SSB index 1706a-e of the SSB transmission. For example, the SSB index 1706a-e may be equal to candidate SSB index. If, for example, a WTRU detects an SSB at a specific SSB occasion ι̅ or i and ι̅≥N or i≥N, the WTRU may test the QCL assumption (e.g., as described herein) between ι̅ and ι̅−N or between i and i−N. Based on the test, the WTRU may determine whether the detected SSB is received via the RIS-to-WTRU path or the gNB/TRP-to-WTRU direct path. For example, if the WTRU determines that the QCL assumption is valid (e.g., between the candidate SSB index and the SSB index), then the WTRU may determine that the SSB was transmitted via the gNB/TRP-to-WTRU path. If the WTRU determines that the QCL assumption is not valid (e.g., between the candidate SSB index and the SSB index), then the WTRU may determines that the SSB was transmitted via the RIS-to-WTRU path.

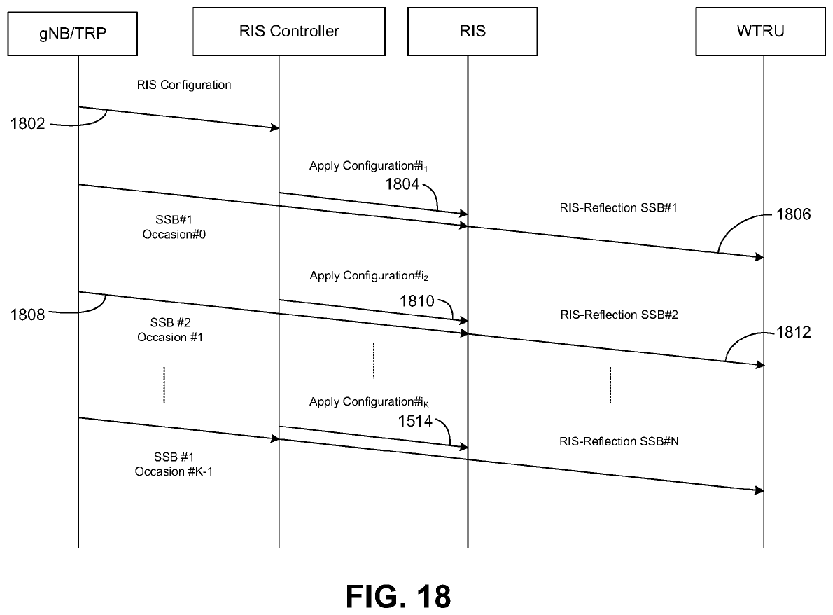

FIG. 18 illustrates an example associated with SSB burst transmissions to a RIS. One or more of the following may apply. In examples, at 1802, a gNB/TRP may configure the RIS controller (e.g., to control a RIS) prior to an SSB transmission. For example, the gNB configuration may include K different RIS configurations. For example, the RIS controller may apply the RIS configuration for each SSB (e.g., SSB #1, SSB #2) with a different configuration. At 1804, the RIS controller may apply configuration #i₁ (e.g., configuration instruction at a time instance) for an SSB #1 occurring at occasion #0. For example, at 1806 configuration #i₁ may reflect SSB #1 in a spatial direction. At 1808, SSB #2 may be transmitted (e.g., again) in the next occasion. For example, at 1810, a different RIS configuration may be applied for SSB #2. For example, at 1812, the different RIS configuration may be applied such that the RIS reflects SSB #2 into a different spatial direction. Configurations may be applied in this manner (as shown at 1814) until all K RIS configurations are accounted for.

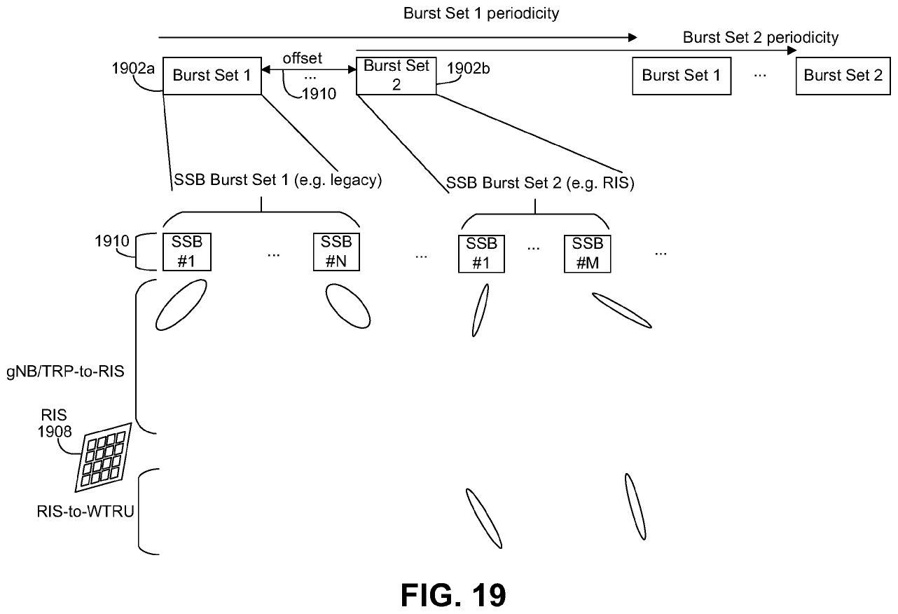

RIS-aware SSB detection may be performed. One or more of the following may apply. FIG. 19 illustrates an example associated with multiple SSB burst sets 1902a-b. Referring to the example illustrated in FIG. 19, a first SSB burst set 1902a may be associated with an implementation that does not include a RIS (e.g., a legacy WTRU), and a second SSB burst set 1902b may be associated with an implementation that includes a RIS 1908. A gNB may transmit extra SSB burst sets towards the RISs, which may be configured reflect the SSBs. For example, the extra SSB burst set may be used by the RIS to perform SSB beam sweeping. Additionally or alternatively, each periodicity of the SSB burst set may be dependent or independent from the other the SSB burst sets. In certain implementations, the RIS controller may configure RIS to reflect an SSB in a given spatial state (e.g., a spatial direction with a specific beam width) during an SSB occasion (e.g., candidate SSB index/position). The candidate SSBs or SSBs in the same SSB burst set (e.g., in a half frame) may be indexed, for example, in an ascending order in time from 0 to L̅ₘₐₓ−1 or from 0 to Lₘₐₓ−1 and L̅ₘₐₓ=Lₘₐₓ. For example, the total number of candidates SSB index may be equal to the total number of SSB indeces 1910.

Each SSB burst may be associated with its own candidate SSB index and SSB burst set index. For example, a DM-RS for PBCH and/or a PBCH payload (e.g., MIB) may indicate the associated candidate SSB index 1910 and/or SSB burst set index for an SSB burst. In such an implementation, a WTRU may detect SSBs via the gNB/TRP-to-WTRU path and/or via the RIS-to-WTRU path at the same or substantially the same time. The WTRU may use the SSB burst set index and/or the candidate SSB index to identify the SSB symbol location, for example, such that an ambiguity associated with the timing synchronization information does not exist. For example, the WTRU may determine the source of a detected SSB (e.g., via the RIS-to-WTRU path and/or the gNB/TRP-to-WTRU direct path) based on the candidate SSB index and/or burst set index. If, for example, a WTRU detects an SSB at an SSB occasion not associated with burst set 1, the WTRU may determine that the detected SSB is received via the RIS-to-WTRU path. If the WTRU detects an SSB at an SSB occasion that is associated with burst set 1, the WTRU may determine that the detected SSB is received via the gNB/TRP-to-WTRU direct path.

As shown in FIG. 19, two SSB burst sets may be used 1902a-b. The starting symbol for the candidate SSB index may include {4, 8, 16, 20}+28·n, n=0, 1 for the first burst set and {4, 8, 16, 20}+28·n, n=3, 4 for the second burst set, respectively. If a WTRU detects an SSB at a starting symbol of 76=16+3·28, the WTRU may determine that the detected SSB is received via RIS-to-WTRU path. The WTU may use the detected candidate SSB index and/or the burst set index to determine the timing synchronization information. For example, the second burst set 1902b may not be transmitted within half frame. If, for example, the burst set index is known by the WTRU when the detects an SSB within a burst set, the timing synchronization information may be known by the WTRU.

Referring again to the example illustrates in FIG. 19, SSB burst set 1 1902a may be associated with an offset from SSB burst set 2 1902b. If the offset 1910 between SSB burst sets 1 1902a and 2 1902b is set to 0, the SSB burst sets 1 1902a and 2 1902b may be back-to-back and/or continuously in time. The offset 1910 for the extra (e.g., second) burst set may be configured by a higher layer and/or based on pre-defined specification.

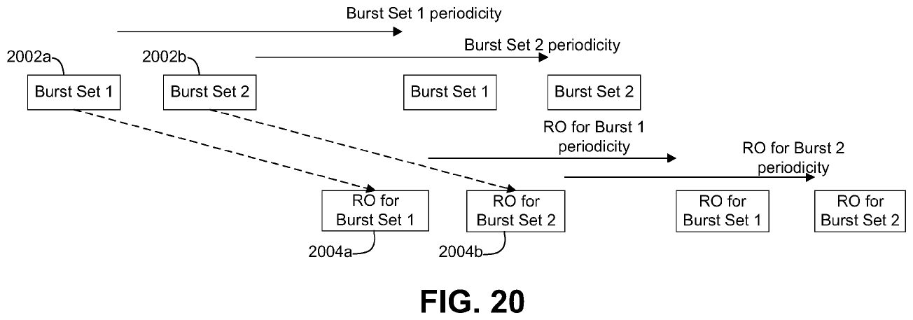

RIS-aided RACH transmission may be performed. One or more of the following may apply. FIG. 20 illustrates an example associated with separated ROs for multiple SSB burst sets 2002a-b. In certain implementations (e.g., NR), a parameter, such as ssb-perRACHOccasionAndCB-PreamblesPerSSB, may specify the number of SSBs (e.g., SSB indexes) that are able to be mapped to a PRACH occasion (RO) and/or the number of preamble indexes that are able to be mapped to an SSB (e.g., SSB index). If an SSB index (e.g., the same SSB index) is used with different spatial directions and/or is mapped to the same RO and/or preamble, one more ambiguities may exist (e.g., with respect to legacy SSB index mapping to a RO and/or preamble). For example, the RIS may use repeated SSBs with the same SSB index (e.g., to perform beam sweeping). In certain implementations, if repeated SSBs map to the same RO and/or preamble, the network may not distinguish which of the SSBs transmitted at the different SSB occasions is detected by the WTRU.

In certain implementations, however, a candidate SSB index may be used for the purpose of SSB to RO and/or preamble mapping for licensed band with RIS (e.g., instead of using the SSB index for SSB to RO and/or preamble mapping). As shown in Table 2, the total number of candidate SSB indexes L̅ₘₐₓ may be equal to 10, and the actual total number of SSB indexes Lₘₐₓ may equal to 4. For example, some of SSB index may be repeated and/or transmitted at different SSB occasions (e.g., candidate SSB index). If the repeated SSBs (SSB indexes) are mapped to the same RO and/or preamble, the network may be able to determine that a WTRU detects the same SSB index with at a different time from a RIS. The network may also determine the appropriate received spatial direction. Determining the appropriate received spatial direction may allow beam selection to complete during the initial access stage.

In certain implementations, the RO 2004a-b for different SSB burst sets 2002a-b may be separated. For example, ROs 2004a-b may be separated based on a network configuration (e.g., SIB/RMSI). A number (e.g., the total number) of candidate SSB indexes may be equal to total number of SSBs in each SSB burst set 2002a-b. SSBs with the same index may be mapped to different Ros 2004a-b, which may decrease the possibility of ambiguities.

As described herein, the candidate SSB index may be greater than the SSB index. Extra candidate SSB indices may be used for SSB index repetition towards a RIS (e.g., the same RIS). In such a case, the RIS controller may apply the configuration to reflect a respective SSB based on the candidate SSB index. The WTRU may determine the source of a reflected SSB (e.g., via the RIS-to-WTRU path or the gNB/TRP-to-WTRU path), for example, based on the detected candidate SSB index and/or the SSB index. Additionally or alternatively, the candidate SSB index may be used for the mapping associated with PRACH occasion and preamble.

As described herein, multiple SSB indices may be transmitted towards a RIS (e.g., the same RIS), and the RIS controller may apply the relevant configuration to reflect SSBs, e.g., based on the candidate SSB index. For example, the SSB index may be used for the mapping associated with PRACH occasion and preamble.

As described herein, SSB burst sets may be broadcast (e.g., by gNB/TRP). One or more of the SSB burst sets may be used by the RIS (e.g., to perform beam sweeping). The RIS may use extra burst sets. The RIS controller may apply the relevant configuration to reflect SSBs based on the candidate SSB index and/or the SSB index (e.g., with a dedicated SSB burst set). ROs may separate. For example, RO separation may be configured for WTRUs (e.g., by the network). A WTRU may transmit PRACH on a dedicated RO, for example, based on the detected SSB index associated with the burst set index.

What is claimed is:

1-20. (canceled)

21. A method performed by a wireless transmit/receive unit (WTRU), the method comprising:
detecting a reflected synchronization signal block (SSB) transmission from a reconfigurable intelligent surface (RIS), wherein the reflected SSB transmission is associated with an index;
determining a source device of the reflected SSB transmission based on the index; and
performing a random access procedure with a source device via the RIS based on the index.

22. The method of claim 21, wherein the SSB transmission is associated with a SSB burst transmission comprising a plurality of SSB transmissions, and wherein each of the plurality of SSB transmissions is associated with the index.

23. The method of claim 22, wherein the plurality of SSB transmissions comprises SSB transmissions that are reflected by the RIS and SSB transmissions that are not reflected by the RIS.

24. The method of claim 22, wherein at least a subset of the plurality of SSB transmissions of the SSB burst transmission are reflected by the RIS at a plurality of different spatial states.

25. The method of claim 22, wherein a spatial state of the RIS is maintained constant during the SSB burst transmission.

26. The method of claim 25, wherein the SSB burst transmission comprises the reflected SSB transmission and a plurality of legacy SSB transmissions, wherein the plurality of legacy SSB transmissions are not reflected by the RIS, and wherein the SSB burst transmission is transmitted according to a legacy SSB transmission pattern.

27. The method of claim 21, wherein determining that the reflected SSB transmission was reflected by the RIS comprises determining that the index associated with the reflected SSB transmission is not quasi collocated (QCL) with a candidate SSB index associated with the reflected SSB transmission.

28. The method of claim 21, wherein the index associated with the reflected SSB transmission is a candidate SSB index, and wherein determining that the reflected SSB transmission was reflected by the RIS comprises determining that the index associated with the reflected SSB transmission is not quasi collocated (QCL) with a burst set index associated with the reflected SSB transmission.

29. The method of claim 21, wherein the index associated with the reflected SSB is an SSB index or a candidate SSB index.

30. The method of claim 21, further comprising:
detecting a second reflected SSB transmission from the reflected RIS, the second reflected SSB transmission being associated with a different spatial beam, than the reflected SSB transmission, and wherein the reflected SSB transmission is associated with a first SSB transmission burst from the source device and the second reflected SSB is associated with a second SSB burst transmission from the source device, and wherein the second reflected SSB transmission is associated with the same index as the reflected SSB transmission, and wherein a number of candidate SSB indices is greater than a number of SSB indices.

31. A wireless transmit/receive device (WTRU) comprising a processor and a memory, the processor configured to:
detect a reflected synchronization signal block (SSB) transmission from a reconfigurable intelligent surface (RIS), wherein the reflected SSB is associated with an index;
determine a source device of the reflected SSB transmission based on the index; and
perform a random access procedure with a source device via the RIS based on the index.

32. The WTRU of claim 31, wherein the SSB transmission is associated with a SSB burst transmission comprising a plurality of SSB transmissions, and wherein each of the plurality of SSB transmissions is associated with the index.

33. The WTRU of claim 32, wherein the plurality of SSB transmissions comprises SSB transmissions that are reflected by the RIS and SSB transmissions that are not reflected by the RIS.

34. The WTRU of claim 32, wherein at least a subset of the plurality of SSB transmissions of the SSB burst transmission are reflected by the RIS at a plurality of different spatial states.

35. The WTRU of claim 32, wherein a spatial state of the RIS is maintained constant during the SSB burst transmission.

36. The WTRU of claim 35, wherein the SSB burst transmission comprises the reflected SSB transmission and a plurality of legacy SSB transmissions, wherein the plurality of legacy SSB transmissions are not reflected by the RIS, and wherein the SSB burst transmission is transmitted according to a legacy SSB transmission pattern.

37. The WTRU of claim 31, wherein determining that the reflected SSB transmission was reflected by the RIS comprises determining that the index associated with the reflected SSB transmission is not quasi collocated (QCL) with a candidate SSB index associated with the reflected SSB transmission.

38. The WTRU of claim 31, wherein the index associated with the reflected SSB is a candidate SSB index, and wherein determining that the reflected SSB transmission was reflected by the RIS comprises determining that the index associated with the reflected SSB transmission is not quasi collocated (QCL) with a burst set index associated with the reflected SSB transmission.

39. The WTRU of claim 31, wherein the index associated with the reflected SSB is an SSB index or a candidate SSB index.

40. The WTRU of claim 31, the processor further configured to:
detect a second reflected SSB transmission from the reflected RIS, the second reflected SSB transmission being associated with a different spatial beam, than the reflected SSB transmission, and wherein the reflected SSB transmission is associated with a first SSB transmission burst from the source device and the second reflected SSB is associated with a second SSB burst transmission from the source device, and wherein the second reflected SSB transmission is associated with the same index as the reflected SSB transmission, and wherein a number of candidate SSB indices is greater than a number of SSB indices.
